(19) United States
(12) Patent Application Publication
(10) Pub. No.: US 2015/0149658 A1
(43) Pub. Date: May 28, 2015

(54) SOFTWARE UPGRADE OF ROUTERS

(71) Applicant: Hangzhou H3C Technologies Co., Ltd., Hangzhou, Zhejiang (CN)

(72) Inventor: Wei Wei, Beijing (CN)

(73) Assignee: Hangzhou H3C Technologies Co., Ltd., Hangzhou, Zhejiang (CN)

(21) Appl. No.: 14/395,399

(22) PCT Filed: Jul. 15, 2013
(86) PCT No.: PCT/CN2013/079378

§ 371 Date: Oct. 17, 2014

(30) Foreign Application Priority Data
Aug. 7, 2012 (CN) 201210277932.1

(51) Int. Cl. H04L 12/771; H04L 12/773; G06F 9/445

(52) U.S. Cl. CPC H04L 45/563; G06F 8/67; H04L 45/60
USPC 709/242

(57) ABSTRACT

According to an example a router includes a control plane CPU, a data plane CPU, a first memory area and a second memory area independent from the first memory area. When the router upgrades its software, the control plane CPU is reset and clears the first memory area. After being reset, the control plane CPU loads a new version control plane program into the first memory area and runs the new version control plane program in the first memory area.

### BACKGROUND

Routers are important devices in a network that perform data routing and forwarding. Routers may be divided into two types: software forwarding router and hardware forwarding router, where data forwarding is implemented by software and hardware respectively. Software forwarding routers refer to routers which use central processing units (CPUs) to forward data. Hardware forwarding routers generally include routers which use Network Processor (NP), Application Specific Integrated Circuit (ASIC) or Field Programmable Gate Array (FPGA) etc. to forward data.

### BRIEF DESCRIPTION OF THE DRAWINGS

Features of the present disclosure are illustrated by way of example(s) and not limited in the following figure(s), in which like numerals indicate like elements, in which:

FIG. 1 shows an architecture diagram of a software forwarding router according to one example of the present disclosure;

FIG. 2 is a flowchart of a software upgrade method for a software forwarding router according to one example of the present disclosure;

FIG. 3 is a structure diagram of a memory area 13 before new version data plane program codes are written into the memory area 13 according to one example of the present disclosure;

FIG. 4 is a structure diagram of the memory area 13 after the new version data plane program codes are written into the memory area 13 according to one example of the present disclosure;

FIG. 5 is a structure diagram of a control plane central processing unit (CPU) according to one example of the present disclosure.

### DETAILED DESCRIPTION

For simplicity and illustrative purposes, the present disclosure is described by referring mainly to examples thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. Throughout the present disclosure, the terms “a” and “an” are intended to denote at least one of a particular element. As used herein, the term “includes” means includes but not limited to, the term “including” means including but not limited to. The term “based on” means based at least in part on.

Initial software upgrades of devices, particularly software upgrades of embedded systems, mainly depend on restarting of software. However, this process may last for a long time, and a service may be in an interrupted state during the software upgrade process. For some core devices or devices in some special applications, such interruption cost is unacceptable.

In-Service Software Upgrade (ISSU) is an upgrade mode which can ensure that a service is not interrupted, or interrupted with a shorter interrupt time, during software upgrade. According to ISSU, a service may remain in a normal state during an upgrade process of a device supporting the ISSU. Thus, ISSU is able to provide a software upgrade mode with high availability for users.

Hardware forwarding routers may support ISSU in a manner similar to that of switches, i.e., during a software upgrade process, a central processing unit (CPU) is restarted while a forwarding chip responsible for forwarding services is not restarted to avoid interruption.

However, since a software forwarding router uses a CPU for forwarding services, and the CPU may requires a restart, the software forwarding router may not be able to implement ISSU to perform a software upgrade without service interruption.

In the present disclosure, a multi-core CPU of a router can upgrade its software. The software may include machine readable instructions executable by a CPU core or another type of processing circuit. The software may include control plane program(s) and/or data plane programs(s) described below. The router may include a data plane CPU responsible for data packet forwarding processing and a control plane CPU responsible for tasks (including processing protocol packets) except for the data packet forwarding processing. Each of the data plane CPU and the control plane CPU may include multiple CPU cores and modules. The modules may be machine readable instructions executable by the CPU cores to perform the functions of their respective plane. A memory may be divided into a first memory area serving the control plane CPU and a second memory area serving the data plane CPU. During the software upgrade process of the router, only the control plane CPU is reset and only the first memory area is cleared. For example, the control plane CPU is reset and the first memory area is cleared without resetting the data plane CPU and without clearing the second memory area. After being reset, the control plane CPU loads and runs new version control plane programs. In this process, the data plane CPU remains in an operating state and the second memory area is not cleared. Thus, the data plane CPU responsible for data packet forwarding processing (i.e., service forwarding processing) may still operate normally to implement the data packet forwarding processing during a software upgrade process of the control plane CPU. Therefore, forwarding services are not interrupted, ISSU is supported and availability of the software forwarding router is improved.

Examples of the present disclosure will be described in detail with reference to the accompanying drawings and examples.

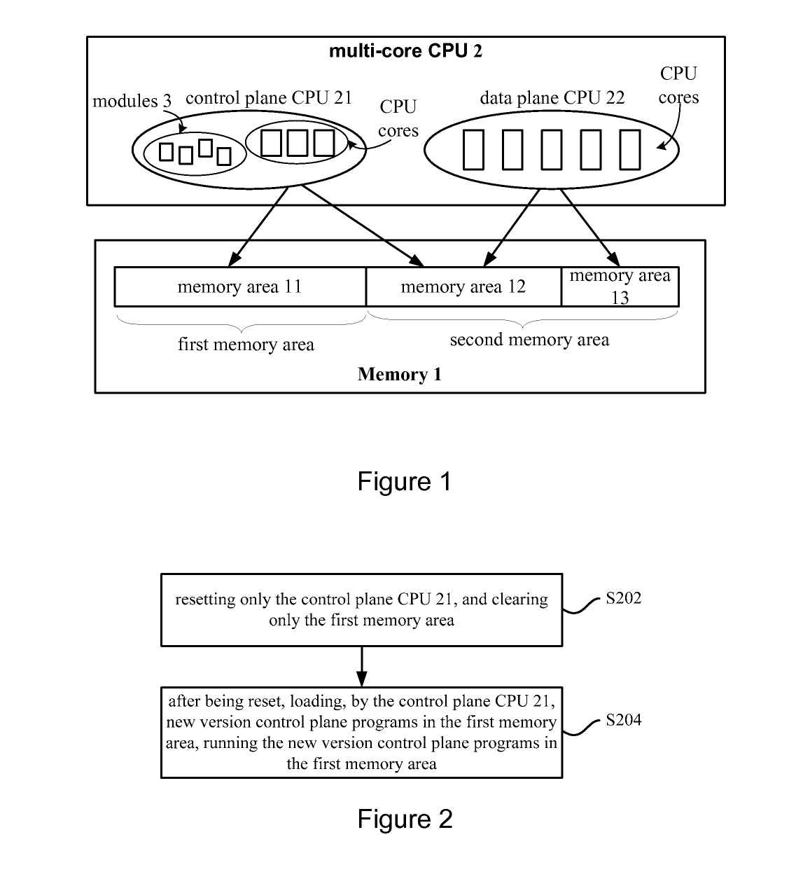

One example of the present disclosure provides a router which forwards data packets through a central processing unit (CPU) and may be referred to as a “software forwarding router”. An architecture diagram of the example router is shown in FIG. 1. The router includes a CPU 2 which may be a multi-core CPU (i.e., including a plurality of CPU cores). Now that a multi-core CPU is becoming more popular, software forwarding routers may be designed based on multi-core CPUs. Besides, the router includes a memory 1 which comprises two memory areas that are independent of each other: a first memory area and a second memory area.

In one example, the multi-core CPU 2 of the router includes two parts: control plane CPU 21 and data plane CPU 22. The control plane CPU 21 is responsible for processing tasks including handling protocol packets, generating and issuing forwarding entries. Other functions of the router, such as management, etc., may also be processed in the control plane CPU 21. The protocol packets may include a variety of routing protocol packets, and may also include network management protocol packets. The data plane CPU 22 is responsible for data packet forwarding processing. The data packets may include packets to be forwarded by the router through looking up a routing table.

Each of the control plane CPU 21 and the data plane CPU 22 may include any number of CPU cores of the multi-core CPU 2. The specific number may be any suitable number, e.g. as determined by product type. The first memory area (labeled as “memory area 11” in FIG. 1) serves the control plane CPU 21, and is to store data, codes, etc. of programs relating to a variety of protocols. For example, the first memory area may store programs (i.e., control plane program) relating to a routing protocol. The routing protocol may be Routing Information Protocol (RIP), Interior Gateway Protocol (IGP), Open Shortest Path First (OSPF), and so on. The first memory area may also store programs relating to a network management protocol and so on. The control plane CPU 21 runs these programs to implement processing of routing protocol packets, network management protocol packets, and so on, for example, generating and issuing forwarding entries of data packets according to routing protocol packets, sending routing protocol packets to other routers, and executing corresponding device management according to network management protocol packets, and so on.

The second memory area is to store forwarding entries which are needed by the data plane CPU 22 to implement data packet forwarding processing, and programs (i.e., data plane program) relating to the data packet forwarding processing. When the data plane CPU 22 forwards data packets, the data plane CPU 22 may look up the forwarding entries in the second memory area. When the control plane CPU 21 generates forwarding entries, the control plane CPU 21 actively issues the generated forwarding entries. The second memory area may be further divided into two storage regions which may be labeled as “memory area 12” and “memory area 13”. One storage region (for example, memory area 12) may be used to store forwarding entries, and the other storage region (for example, memory area 13) may be used to store a program (i.e., a data plane program) relating to the data packet forwarding process. The storage regions may be used to store other information not specifically mentioned here.

For convenience of description, a second memory area with two storage regions will be used as an example in the following.

During normal operation of the router, the control plane CPU 21 uses a control plane program in the memory area 11 to perform processing of protocol packets. Once a forwarding entry is generated, the generated forwarding entry is written (i.e. issued) into the memory area 12. The data control plane CPU 22 runs a data plane program in the memory area 13. When the data control plane CPU 22 receives a data packet, the data control plane CPU 22 may look up forwarding entries in the memory area 12 and forwards the data packet to the outside, or discards the data packet, or sends the data packet to the control plane CPU 21 to be further processed.

It should be noted here that since the forwarding entries in the memory area 12 are accessed by the control plane CPU 21 and the data plane CPU 22, atomic operations and delay deletion technology such as Read-Copy Update (RCU) may be used to avoid critical section problem. The control plane CPU 21 includes modules 3 to perform the software upgrade and other functions described herein. The modules 3 may include a determination module 10, a conversion module 20, a write module 30 and a deleting module 40 described in further detail below with respect to FIG. 5. The modules 3 may be executed by the CPU cores in the control plane CPU 21 and may be stored in non-volatile memory but the modules 3 may not be cleared when control plane programs are cleared. The data plane CPU 22 may also include modules, although not shown, for performing the methods, processes and functions described herein.

When the router's software needs to be upgraded, a user may issue an upgrade instruction to the router through a Personal or Private Computer (PC), or other devices, and this is not specifically limited here. As shown in FIG. 2, an example of the router's software upgrade process includes following blocks.

Block S202: resetting only the control plane CPU 21, and clearing only the first memory area. For example, the control plane CPU 21 is reset and the first memory area is cleared without resetting the data plane CPU 22 and without clearing the second memory area.

At this time, the data plane CPU 22 continues running, and the memory area 12 and memory area 13 in the second memory area are not cleared.

Generally, resetting may include two processes: jumping to a specific location, and then, starting initialization based on an instruction at this specific location. In the above block S202, in the resetting process, the control plane CPU 21 first jumps to the specific location, and then starts initialization from the specific location. In the initialization process, the action of clearing the first memory area may be implemented.

Block S204: after being reset, loading, by the control plane CPU 21, control plane programs (hereinafter referred as “new version control plane programs”) contained in a new version software program in the first memory area, and running the new version control plane programs in the first memory area. For example, the new version software program may be a new version embedded system software program.

Before loading, the new version software program may be stored in a file system, a flash, a mobile storage device or a special area of a memory and this is not specifically limited here.

Since a version of software program of the router may include two parts: the control plane program(s) and the data plane program(s), in practice, when the control plane CPU 21 loads the new version control plane programs, data plane programs contained in the new version software program may be simultaneously loaded into the first memory area, that is, the whole new version software program is loaded into the first memory area. It also may load only the new version control plane programs into the first memory area, and this is not specifically limited here.

In the process of running the new version control plane programs, the control plane CPU 21 may write codes and data of a variety of protocols into the first memory area.

In the present disclosure, the multi-core CPU 2 of the router is divided into the data plane CPU 22 responsible for data packet forwarding processing and the control plane CPU 21 responsible for tasks (including processing protocol packets) except for the data packet forwarding processing, and the memory 1 is divided into the first memory area serving for the control plane CPU 21 and the second memory area serving for the data plane CPU 22. In the process of upgrading software of the router, only the control plane CPU 21 is reset and only the first memory area is cleared. After being reset, the control plane CPU 21 loads and runs new version control plane programs. In this process, the data plane CPU 22 remains in an operating state and the second memory area is not cleared. Thus, it can be ensured that the data plane CPU 22 responsible for data packet forwarding processing (i.e., service forwarding processing) still may operate normally to perform the data packet forwarding processing during a software upgrade process of the control plane CPU 21. This ensures that service is not interrupted, supports the implementation of ISSU and improves availability of the software forwarding router.

A software upgrade process of the router shown in FIG. 1 may include following blocks.

At a first block, software of the control plane CPU 21 is upgraded.

In this block, only the control plane CPU 21 is reset and only the memory area 11 is cleared. Meanwhile, the data plane CPU 22 continues running and the memory area 12 and the memory area 13 are not cleared. After the control plane CPU 21 is reset, the control plane CPU 21 loads the new version control plane programs into the first memory area and runs the new version control plane programs in the first memory area.

After the new version control plane programs run in the control plane CPU 21, performing the following second block.

At the second block, data plane entries are upgraded.

This block may be applied in a situation where there is a change in format of data plane entries, i.e., a format of forwarding entries corresponding to the new version control plane programs is different from a format of forwarding entries corresponding to old version control plane programs. The forwarding entries corresponding to the new version control plane programs may be referred to as “data plane entries of the new version”. The forwarding entries corresponding to old version control plane programs may be referred to as “data plane entries of the old version”. If there is no change in the format of the data plane entries, then this block is skipped and the following third block performed.

In practice, for example, predetermined version numbers may be used to determine whether the format of the data plane entries of the new version is the same as the format of the data plane entries of the old version. For example, when developing a software program, version levels may be prescribed. Format of data plane entries of software programs which belongs to the same version level is not changed (i.e., the same). Thus, whether a version number of the new version and a version number of the old version belong to the same version level may be determined. If the version number of the new version and the version number of the old version belong to the same version level, then it may be determined that the format of the data plane entries of the new version is the same as the format of the data plane entries of the old version. If they do not belong to the same version level, then it may be determined that the format of the data plane entries of the new version is different from the format of the data plane entries of the old version. Any other suitable way may be used to determine whether the format of the data plane entries of the new version is the same as the format of the data plane entries of the old version, and this is not specifically limited here.

After the control plane CPU 21 runs the new version control plane programs, the control plane CPU 21 traverses each forwarding entry (i.e., data plane entry in the memory area 12), converts contents of forwarding entries of the old version into contents of forwarding entries of the new version. That is, the control plane CPU 21 performs format conversion on the forwarding entries in the memory area 12 so as to be consistent with the format of the data plane entries of the new version. The forwarding entries are upgraded to prepare for subsequent upgrade of the data plane programs.

One way of converting the format of forwarding entries may be as follows. For example, if each forwarding entry of the old version includes 3 fields and each forwarding entry of the new version includes 4 fields (i.e. the new version has a newly added field when compared with the old version), then a default value may be assigned to the newly added field. The newly added field may be located at an end of the entry structure. In this way, when the data plane CPU 22 which still runs the old version data plane programs read forwarding entries of the new version, the data plane CPU 22 still may work normally.

In one example, when converting the format of forwarding entries, there may be a critical section where the control plane CPU 21 and the data plane CPU 22 access the same memory area (i.e., memory area 12). The critical section problem may be avoided by using atomic operations and delay deletion technology.

After all forwarding entries in the memory area 12 have been converted, the following third block is performed.

At the third block, data plane programs are upgraded.

This block may be applied in a situation where there is a change in data plane programs (i.e., old version data plane programs are different from the new version data plane programs) and the old version data plane programs need to be upgraded. If there is no change in the data plane programs, then at this time, the entire software upgrade process may end.

In practice, one way of determining whether the new version data plane programs are the same as the old version data plane programs is similar to the way of determining whether the format of the data plane entries of the new version is the same as the format of the data plane entries of the old version in the above second block. The way of determining whether the new version data plane programs are the same as the old version data plane programs may include determining whether a version number of the new version and a version number of the old version belong to the same version level. If the version number of the new version and the version number of the old version belong to the same version level, then it may be determined that the new version data plane programs are the same as the old version data plane programs. If they do not belong to the same version level, then it may be determined that the new version data plane programs are different from the old version data plane programs. Any other suitable way may be used to determine whether the new version data plane programs are the same as the old version data plane programs, and this is not specifically limited here.

Upgrading of the data plane programs may include following blocks.

Block a: the control plane CPU 21 writes the new version data plane programs into the memory area 13; after the writing is completed, performing block b.

In practice, if the control plane CPU 21 loads the entire new version software program into the first memory area, then in this block, it may need to copy the new version data plane programs in the first memory area into the second memory area. If the control plane CPU 21 loads only the new version control plane programs into the first memory area, then in this block, it may need to write the new version data plane programs from a file system, a FLASH, a mobile storage device or a special area of the memory into the second memory.

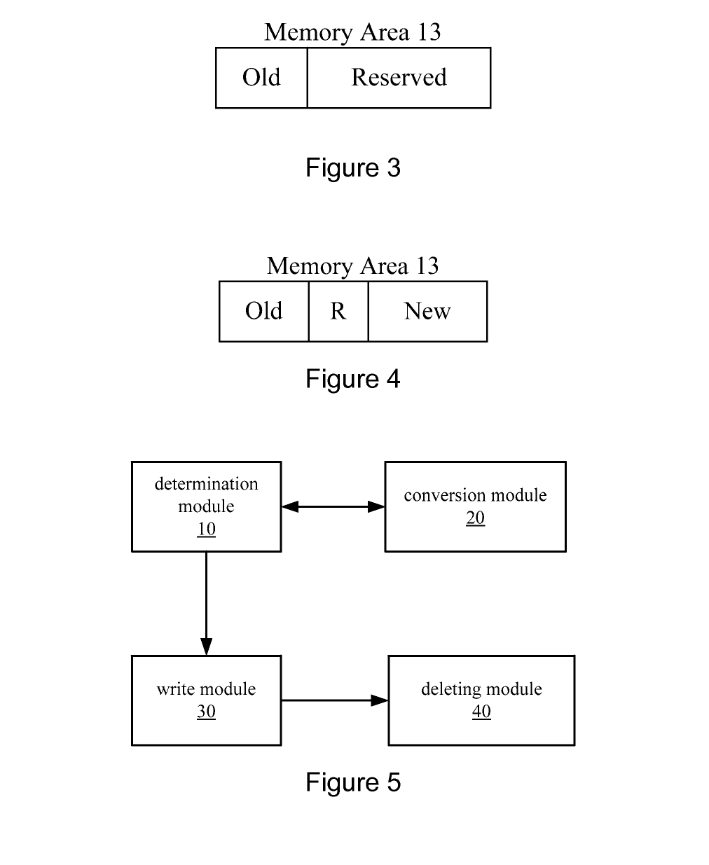

As shown in FIG. 3, a partial memory of the memory area 13 stores the old version data plane programs (represented with “Old” in FIG. 3). The control plane CPU 21, which runs the new version control plane programs, loads the new version data plane programs into a reserved area. As shown in FIG. 4, the reserved area is independent of a save location of the old version data plane programs. The reserved area does not overlap with the save location of the old version data plane programs. In FIG. 4, “R” represents remaining reserved area, and “New” represents the new version data plane programs.

Block b: multiple CPU cores in the data plane CPU 22 run the new version data plane programs in the memory area 13 one by one (i.e., the multiple CPU cores in the data plane CPU 22 switch from the old version data plane programs to the new version data plane programs). “One by one” means that the CPU cores take turns to switch from the old version to the new version (or run the new version). For example, after one CPU core completes the switching (or running), then the next CPU core begins the switching (or running). Through the manner of switching (or running) one by one, it may be ensured that at least one CPU core is in the running or operating state and service is not interrupted.

Block c: after all the CPU cores in the data plane CPU 22 have switched to the new version data plane programs, the control plane CPU 21 deletes the old version data plane programs in the memory area 13.

The router's software upgrade process is now complete.

It can be seen from the above description, comparing to the old version, if there is no change in both of the format of the data plane entry and the data plane programs of the new version software program, then only the above first block is performed to complete the entire software upgrade process. In another example, if only the format of the data plane entry of the new version software program has changed, then only the above first and second blocks are performed to complete the entire software upgrade process. In a further example, if only the data plane program of the new version software program has changed, then the above first and third blocks are performed to complete the entire software upgrade process.

It can be seen from the above examples, in order to implement the example software upgrade method, when the router's software is upgraded, the control plane CPU 21 resets and only clears the first memory area. After being reset, the control plane CPU 21 loads the new version control plane programs into the first memory area, and runs the new version control plane programs in the first memory area.

As shown in FIG. 5, the control plane CPU 21 of an example router may include the following functional modules: the determination module 10, the conversion module 20, the write module 30 and the deleting module 40. These modules may be included in the modules 3 shown in FIG. 1.

After the control plane CPU 21 runs the new version control plane programs, the determination module 10 is to determine whether the format of the data plane entries of the new version is the same as the format of the data plane entries of the old version.

When the determination module 10 determines that the format of the data plane entries of the new version is different from the format of the data plane entries of the old version, the conversion module 20 performs format conversion on the forwarding entries in the second memory area so as to be consistent with the format of the data plane entries of the new version.

Here, when the determination module 10 determines that the format of the data plane entries of the new version is the same as the format of the data plane entries of the old version, or after the conversion module 20 has performed format conversion on the old forwarding entries in the second memory area, the determination module 10 further determines whether it is needed to upgrade the data plane programs (e.g. by determining whether the old version data plane programs are the same as the new version data plane programs). If an upgrade is not needed (i.e., the old version data plane programs are the same as the new version data plane programs), then directly exiting the entire software upgrade process. If an upgrade is needed (i.e., the old version data plane programs are different from the new version data plane programs), then triggering the write module 30.

The write module 30 writes the new version data plane programs into a reserved area of the second memory area. The reserved area is independent of the save location of the old version data plane programs, so that the multiple CPU cores contained in the data plane CPU 22 switch one by one from the old version data plane programs to the new version data plane programs. “One by one” means that after one CPU core completes the switching, then the next CPU core begins the switching.

After all CPU cores in the data plane CPU 22 have switched to the new version data plane programs, the deleting module 40 deletes the old version data plane programs in the second memory area, and then exits the entire software upgrade process.

Since the control plane CPU 21 includes a plurality of CPU cores, it may also be considered as that each CPU core may include the four functional modules in FIG. 5.

The methods, units and devices described herein may be implemented by hardware, machine-readable instructions or a combination of hardware and machine-readable instructions. Machine-readable instructions used in the examples disclosed herein may be stored in storage medium readable by multiple processors, such as hard drive, CD-ROM, DVD, compact disk, floppy disk, magnetic tape drive, RAM, ROM or other proper storage device. Or, at least part of the machine-readable instructions may be substituted by specific-purpose hardware, such as custom integrated circuits, gate array, FPGA, PLD and specific-purpose computers and so on.

A machine-readable storage medium is also provided to store instructions to cause a machine to execute a process as described according to examples herein. In one example, there is provided a system or apparatus having a storage medium that stores machine-readable program codes for implementing functions of any of the above examples and that may cause the system or the apparatus (or CPU or MPU) to read and execute the program codes stored in the storage medium.

In this situation, the program codes read from the storage medium may implement any one of the above examples.

The storage medium for storing the program codes may include floppy disk, hard drive, magneto-optical disk, compact disk (such as CD-ROM, CD-R, CD-RW, DVD-ROM, DVD-RAM, DVD-RW, DVD+RW), magnetic tape drive, Flash card, ROM and so on. The program code may be downloaded from a server computer via a communication network.

It should be noted that, alternatively to the program codes being executed by a computer, at least part of the operations performed by the program codes may be implemented by an operation system running in a computer following instructions based on the program codes to implement any of the above examples.

In addition, the program codes implemented from a storage medium are written in a storage in an extension board inserted in the computer or in a storage in an extension unit connected to the computer. In this example, a CPU in the extension board or the extension unit executes at least part of the operations according to the instructions based on the program codes to implement any of the above examples.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What have been described and illustrated herein are examples along with some variations. The terms, descriptions and figures used herein are set forth by way of illustration only and are not meant as limitations. Many variations are possible within the spirit and scope of the subject matter, which is intended to be defined by the following claims—and their equivalents—in which all terms are meant in their broadest reasonable sense unless otherwise indicated.

What is claimed is:

1. A router to forward data packets, the router comprising:
a multi-core central processing unit (CPU) including a control plane CPU and a data plane CPU;
a first memory area; and
a second memory area independent from the first memory area, wherein
the first memory area is to store a control plane program relating to a routing protocol;
the second memory area is to store a data plane program relating to data packet forwarding processing;
the data plane CPU is to run the data plane program in the second memory area to process data packets;
the control plane CPU is to run the control plane program in the first memory area to process protocol packets;
when the router upgrades its software, the control plane CPU is to reset and to clear the first memory area without resetting the data plane CPU and without clearing the second memory area;
after being reset, the control plane CPU is to load a new version control plane program into the first memory area and run the new version control plane program in the first memory area.

2. The router according to claim 1, wherein the second memory area is further to store forwarding entries generated and issued by the control plane CPU, and the data plane CPU is further to forward the data packets according to the forwarding entries in the second memory area, and the control plane CPU comprises:
a determination module to determine whether a format of new forwarding entries corresponding to the new version control plane program is the same as a format of old forwarding entries corresponding to an old version control plane program before upgrading;
a conversion module to perform format conversion on the old forwarding entries in the second memory area, wherein the format conversion includes converting the format of the old forwarding entries to be consistent with the format of the new forwarding entries when the determination module determines that the format of the new forwarding entries is different from the format of the old forwarding entries.

3. The router according to claim 2, wherein the control plane CPU executes a write module, wherein
when the determination module determines that the format of the new forwarding entries is the same as the format of the old forwarding entries, or after the conversion module has performed format conversion on the old forwarding entries in the second memory area, the determination module is further to determine whether to upgrade the data plane program; and
the write module is to write new version data plane program into a reserved area of the second memory area when the determination module determines to upgrade the data plane program, and the reserved area is independent of a save location of the old version data plane program.

4. The router according to claim 3, wherein the data plane CPU comprises CPU cores that switch one by one from the old version data plane program to the new version data plane program, and to switch one by one comprises after one of the CPU core switches to the new version data plane program, a next CPU core of the CPU cores begins to switch to the new version data plane program.

5. The router according to claim 4, wherein the control plane CPU further comprises:
a deleting module to delete the old version data plane program in the second memory area after the CPU cores of the data plane CPU have switched to the new version data plane program.

6. A software upgrade method for a router, wherein the router is to forward data packetsand comprises a multi-core CPU, a first memory area and a second memory area independent from the first memory area, and the multi-core CPU comprises a control plane CPU and a data plane CPU, the method comprising:
storing, in the first memory, a control plane program relating to a routing protocol, and the control plane CPU is to run the control plane program in the first memory area to process protocol packets;
storing, in the second memory area, a data plane program relating to data packet forwarding processing, and the data plane CPU is to run the data plane program in the second memory area to process data packets;
when the router upgrades its software, resetting the control plane CPU and clearing the first memory area without resetting the data plane CPU and without clearing the second memory area;
after being reset, loading, by the control plane CPU, a new version control plane program into the first memory area and running the new version control plane program in the first memory area.

7. The method according to claim 6, wherein after the running the new version control plane program in the first memory area, the method further comprises:
determining, by the control plane CPU, whether a format of new forwarding entries corresponding to the new version control plane program is the same as a format of old forwarding entries corresponding to an old version control plane program before upgrading;
when it is determined that the format of the new forwarding entries is different from the format of the old forwarding entries, performing, by the control plane CPU, format conversion on the old forwarding entries in the second memory area, wherein the format conversion includes converting the format of the old forwarding entries to be consistent with the format of the new forwarding entries.

8. The method according to claim 7, wherein after performing, by the control plane CPU, the format conversion on the old forwarding entries in the second memory area, or determining that the format of the new forwarding entries is the same as the format of the old forwarding entries, the method further comprises:
determining whether to upgrade the data plane program; and
if it is determined to upgrade the data plane program, writing, by the control plane CPU, new version data plane program into a reserved area of the second memory area, wherein the reserved area is independent of a save location of the old version data plane program.

9. The method according to claim 8, wherein the data plane CPU comprises CPU cores and after writing, by the control plane CPU, new version data plane program into a reserved area of the second memory area, the method further comprises:
switching the CPU cores one by one from the old version data plane program to the new version data plane program, wherein the switching comprises after one of the CPU core switches to the new version data plane program, switching a next CPU core of the CPU cores to the new version data plane program.

10. The method according to claim 9, wherein after the CPU cores of the data plane CPU have switched to the new version data plane program, the method further comprises:
deleting, by the control plane CPU, the old version data plane program in the second memory area.
